(19) United States
(12) Patent Application Publication
(10) Pub. No.: US 2019/0318644 A1
(43) Pub. Date: Oct. 17, 2019

(54) END TO END EDUCATIONAL SYSTEM AND METHOD

(71) Applicant: Nelson Education Ltd., Scarborough (CA)

(72) Inventors: Saqib Aleem, Scarborough (CA); Steve Brown, Scarborough (CA); Ben Higgins, Scarborough (CA); Jason Miller, Scarborough (CA)

(73) Assignee: Nelson Education Ltd., Scarborough, ON (CA)

(21) Appl. No.: 16/464,656

(22) PCT Filed: Nov. 11, 2017
(86) PCT No.: PCT/CA2017/051392

§ 371 Date: May 28, 2019

Related U.S. Application Data
(60) Provisional application No. 62/425,663, filed on Nov. 23, 2016.

(51) Int. Cl. G09B 7/00; G06F 21/45

(52) U.S. Cl. CPC G09B 7/00; G06F 21/45

(57) ABSTRACT

A distributed network of computing equipment and software to configure and distribute education content to students, educators and administrators. The system comprises tablets, or other mobile devices for each student and educator, each uniquely identified within the system. Content from servers is securely distributed to the mobile devices accessed through a single sign on based on the requirements of each user both initially at the time they begin a program, and updated or removed during a particular course or program. The content includes education applications that provide interactive features with textbook material, practice, and assessments, the activity of which can be tracked and configured by the educators and administrators.

### CROSS-REFERENCE TO RELATED APPLICATIONS

This application claims priority to U.S. Provisional Application No. 62/425,663 filed Nov. 23, 2016, the entirety of which is incorporated herein by reference.

### TECHNICAL FIELD

The present disclosure relates to the electronic delivery of educational content and services. More particularly it relates to the administration, delivery and updating of educational content.

### TECHNICAL BACKGROUND

Traditionally, educational content was prepared by publishers, printed in textbooks and distributed to students at the beginning of the school year or course. The textbooks would be used by the students and in some cases re-used by subsequent students.

While textbooks would be periodically updated, the cost to do so, along with republishing the books and discarding the previous editions of the books is costly. In addition, each student would receive the same textbook and therefore the same content.

It is therefore desirable to provide a system for management and delivery of educational content electronically and flexibly to students.

### BRIEF DESCRIPTION OF THE DRAWINGS

In drawings which illustrate by way of example only embodiments of the present disclosure, in which like reference numerals describe similar items throughout the various figures,

FIG. 1 is an education institution deployment flow chart.

FIG. 2 is a personal device deployment flow chart.

FIG. 3 is a content ingestion flow chart.

FIG. 4 is a system architecture block diagram.

FIG. 5 is a physical system block diagram.

FIG. 6 is an institution device setup and authentication flow chart.

FIG. 7 is an MDM setup flow chart.

FIG. 8 is a non-MDM alternative single-sign-on flow chart.

FIG. 9 is a content and assessment flow chart.

FIG. 10 is a practice or assessment flow chart.

FIG. 11 is a representation of a user interface for navigating content.

FIG. 12 is a schematic diagram of an aspect of the system.

### DETAILED DESCRIPTION

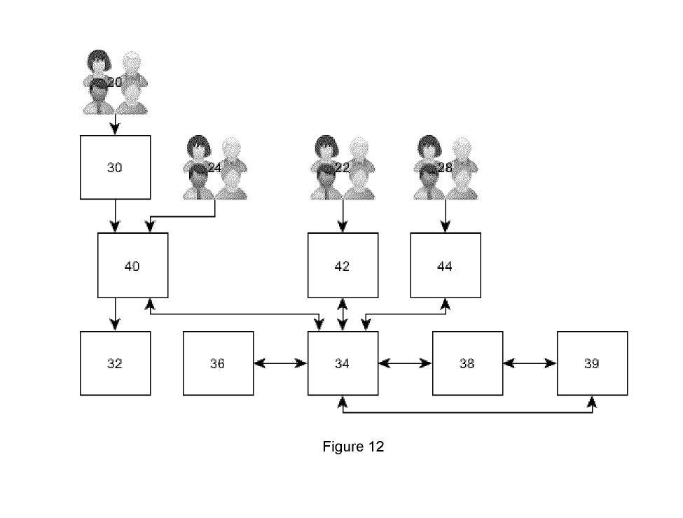

Embodiments described here are directed to an integrated framework that configures, distributes and manages an end-to-end solution for educational institutions. With reference to FIG. 12, the system 10, or framework, may be used by students 20, parents 22, educators 24 (instructor/teacher) and content providers 26 in a closed and secure environment to provide an immersive and personalized learning experience. The system may also be accessed by administrators 28 such as senior education institution staff, the provider of the system, content providers, technology administrators and other educators.

The system 10 is intended to replace the physical educational materials within the student backpack with a technology solution that can be used throughout their learning journey. The solution provides multi-country/multi-language support and as will be described below, provides integration flexibility.

The system 10 uses a mobile interface 30 for the students. The mobile interface 30 is preferably tablets or hybrid 2-1 laptop/tablet devices, which may be iOS, Android, Windows, or Chromebooks based devices, although other mobile devices may be used that provide sufficient connectivity, and interactivity features, such as smartphones, or laptops. A browser on a general purpose computer may be used as a mobile interface to access the content. After the prescribed course or program duration is complete, the mobile interface 30 may be re-configured and re-deployed. The mobile interface 30 may be provided through a device, such as a smartphone, tablet or laptop, provided by the user, that runs software, such as an app that integrates with the other components of the system.

The system 10 may use additional hardware 32 with classrooms or other learning environments, such as screen mirroring devices or software. The screen mirroring devices or software may include such systems as Apple TV, ChromeCast, Windows Display Adaptor, direct tablet to screen connection cables (such as HDMI), LANSchool or other mirroring or projection based software, wireless printers, wireless keyboards, wireless mouse. The combination of mobile interfaces 30 and classroom hardware provide an end-to-end immersive and interactive education experience within the classroom.

Preferably an application 40 or other software is installed on the mobile interface 30, such as through an ‘app’ or software module to provide the core functionality on the mobile interface. The application 40 may provide an array of learning functionality tools, such as rich and immersive content, practice/assessments, a portfolio for personal data, messaging, collaboration, offline access, cloud-based storage and synchronization.

This functionality may be provided through software on the mobile device, on one or more servers 34, or a combination. An analysis module 36 that tracks and understands software and content usage may also be included and may guide the student through practice and/or assessment functionality on the app 40, including through an adaptive and personalized guide, artificial intelligence/ai, personalized content and pedagogy recommendations may also be provided.

The app 40 may be set up on the mobile interface 30 for students and educators prior to the start of the semester or program and have content available when the student starts the class. Preferably, the application 40 and mobile interface 30 has all the content available prior to the student starting the class. Educators may use a mobile interface 30 with the app 40 and connect to additional hardware 32.

A lite version 42 of the core application 40 with limited features may be installed on personal devices such as for students, parents and educators. Such a lite version 42 may be installed by the user onto the device.

The applications 40 and 42 may be available for use even without the educational institution deployment and may provide similar features with the option to subscribe to additional content. Several software programs created across other technologies such as the web or client/server with similar features as the core 40 and lite apps 42 may provide greater accessibility.

Other apps may be installed through an mobile device management (MDM) software 50 based on the configuration details or an institution. For senior staff, administrators and/or educators, the software on the mobile interface may provide high level reporting on large number of students through a dashboard that may provide ability to drill down into more detailed information. An administrative app 44 or apps to support the administration of the system, such as MDM, content management and ingestion, administration tools and services may also be provided.

Educational content 60 is distributed and displayed or rendered through the system and in particular on the core, lite and other apps. Rich and immersive content, practice and assessments features, packaged and personalized to the user may be provided through the mobile device through pre-installed and other downloadable content.

The software on the interface 30 may capture robust learning analytics based on content usage by collecting detailed usage data. The data collected may include large volumes of frequent and complex usage data such as how much time is spent reviewing certain content, responses to practice/assessment questions, search and browse trends, topics that are challenging based on time spent and correct/incorrect answers, and interest. The data collect may leverage artificial intelligence and machine learning to provide recommendations, further personalization and adapt for the user's needs as well as feedback to the educational institute and the content providers.

The system 10 may also provide administration tools and services. These tools may assist in the setup and configuration of the solution including the creation, review and deployment of content through a content management system which is accessible through a web or app interface based on user access. Cloud-based services and server side components that interact with the software on the mobile devices and admin tools may capture learning analytics and other data such as profile settings, personal notes, highlights, annotations, preferences. Mobile Device Management administrative tools may assist in the setup of the devices, application.

The embodiment may combine some or all of these components to create a rich and engaging educational eco-system.

Students 20 are the primary user of the system 10. The students may each be provided with a mobile interface 30, such as tablet, hybrid 2-in-1 tablet/laptop, or other mobile device, that has the educational app 40 or other software installed. The app 40, or other software, provides access to the educational content 60. The system may provide an option for a user to install a lite or personal version 42 of the app, with limited features, on their own smartphone, home tablet, or other mobile device. In addition to accessing the educational content, the student functionality may include profile, settings and avatar, agenda, scheduling, messaging, assignments, notifications, search, portfolio.

Educators 24, such as teachers, instructors or other faculty may use the system 10 to leverage tablets or other mobile devices having the app installed and access to content. Additional features for the educators may also be available on the app, such as grading, reporting and administration. The educator primarily includes the teacher or instructor but can include others including teaching assistants, and others involved in educating the students.

Parents and other family members 22 may be able to access information from the educator and communicate back. Preferably there are options on how and when this group of users can receive notifications and the types of notifications.

Senior staff, faculty and administrators 28 interested in macro-level reporting may use a tablet or other device to have access to system dashboard. In addition, support and administrative users may use admin tools and provide support to the other users.

Content providers 26 may have the ability to load their content 60 into the system 10 based on a defined set of standards and guidelines. The system 10 or its administrators 28 may establish an approved set of content providers 26 who may access the system. The ability to provide content usage and other learning analytics, including specific to their content, may be communicated from the system back to the content providers.

Technology administrators may have access to all the administrative tools, mobile device management (MDM) and mobile access management (MAM) tools, app, support tools, and content.

Other educators or employers of the educators may have access to macro-level reporting, such as trends, usage, and other metrics for one or many classes, course or institutions.

A mobile interface 30, such as tablets, hybrid 2-in-1 tablet/laptop or mobile devices may include an operating systems such as Apple iOS, Google's Android, MS Surface's Windows, Chromebooks Chrome OS to use a known system, interoperability and support although other systems may be used. Devices may have an indicator, such as a LED light, activity display or other visible display, preferably on the opposite end from the primary device display, that may be programmed through the educational solution app to trigger certain notifications used in the classroom.

For example, the indicator may indicate that a student wants to ask a question, or has completed a test. The indicator may be used to communicate to the students by indicating the students are to be quiet or that a question is ready to be answered on the display. Different colour indicators may be used to provide different indications.

The mobile interface 30 may be presented with a closed environment for the institution with the ability for the educational institution to customize which features are available on the user devices. For example, the environment may prevent the installation of other apps, games or software on the institution mobile device that are not approved by the provider or institution. Other closed features may include locking the device, monitoring, purging, or other features, including based on MDM, MAM, or Classroom Management System features and control.

The mobile interfaces 30 may be distributed to the students. Alternatively, some or all of the students, may provide their own device on which software is installed to form the mobile interface 30.

Similarly, a mobile interface 30 is distributed to the educators. Not all of the educators may require a mobile interface 30 if hardware is available in the classroom to interface the system, or educators may use their own devices.

The system 10 may include, or use a mirroring device 32. Such a device may allow the instructor or students show what is on their or student mobile interface 30 onto a screen. This can be done for example on Apple iPads using Apple TV, Android tablets with Chromecast, or Windows Surface using MS Wireless Display Adaptor or through classroom management software such as LANSchool, Apple Classroom Management, or others. Also, the system may include the option to do this through a wired connection.

Other accessories for the mobile interfaces 30 may include a wireless or wired keyboards and printer that connect to the interface. Other hardware features 32 may include augmented or virtual reality hardware or headsets as well as gaming consoles where the app can be installed and used as a portal in the class/course room.

The system 10 may further include the option to provide a screen (for example, TV, large monitor, or smart board) to show/share work done on tablets with the entire classroom.

Personal devices may be used at home including iOS, Android or Windows tablets, Chromebooks, smartphones, smartwatches, gaming consoles, Apple TV, Augmented Reality (AR) or Virtual Reality (VR) headsets to access the system 10. The system 10 may include a personal/lite version 42 of the app on these personal devices with limited features. The lite version 42 may connect with the system 10 via an access key or other type of account synchronization, which connects the personal account, set up on the personal device/lite app 42, with the institution account, set up on the institution device 30 or core app 40. An app may also available to be downloaded and used without a connection to the educational institution that may permit the user has the ability to subscribe to content.

A core, or institution, application 40 and other requested or approved apps may be deployed on the mobile interfaces 30, or devices. The specific app functionality deployed may be requested by users, educators or administrators through deployment requests. For example, features of tutoring, polling and clicker may be deployed as needed for specific users. A tutoring feature may allow for the real-time message based tutoring. A class polling feature may allow class polling based on questions posed to the class. Lite/personal app 42 may be available to be installed on a personal tablet or smartphone device and integrated through an access key.

The core app 30 may be installed on the mobile interface for students and teachers. The core app is preferably distributed, installed and configured through an MDM system or via the Apple App Store, Google Store, Microsoft Store, Chrome Web Store as appropriate for a particular operating system on the interface, or via a direct install on device, such as through imaging of the device. The core app may be installed on personal or non-institution deployed devices.

An application with similar functionality as the core app 40 or lite app 42 may be made available for other interfaces. For example an app may be made available for installation as a Web app, Chrome based app, Apple TV app, Xbox/Playstation/Nintendo or other Gaming/Console app, Messages app, Social app (Facebook, Twitter, other), Augmented or Virtual Reality app, or smartwatch app or similar.

Student specific features and content may be included in the core app 40 for each student but also preferably accessible by the teacher/instructor through their interface.

Profile settings may be included in the core app 40 to provide the ability for the student to manage their account settings, profile, password, avatar and other personal settings.

The system 10 may include a digital interactive agenda for each class and/or course. The agenda may include a calendar of activities and events, tasks or comment features for student to fill out on a particular day, comments or sign-off features for parent to fill out for the day, and comments the teacher can fill out.

The system 10 may also include a digital version of a schedule for a class and/or course that may be displayed on the mobile interface 30. The schedule may include features for the students or teachers to share, edit, annotate the schedule. These annotations may be shared with the class or other group, or be personal, and only visible to the student.

The core app 40 may include messaging functionality. The messaging functionality may include a real-time forum, chat or channel for users to post questions and answer. The teacher, the class or course students, or in some instances, parents may post the questions and answers. The messaging functionality may also include direct messaging capabilities between students, parent to teacher, and allow for the reporting of any abuse.

The core app 40 may provide content for the interface that is specific to the course or class for the particular user. The specific courses or classes for a particular user may be determined during the educational institution deployment, such as through a Student Information System (SIS) integration, through an access key, or through existing LMS/classroom management integration. The system may populate the core app 40 with content 60 based on the user's credentials and integration with the SIS of the educational institute. The content may include any assignments specific to the course with due dates.

The core app 40 may include the ability to search for content, messages and other data used in the app from a variety of content sources. The content sources may include one or more of educational publishers, online educational resources (OERs), other content providers, and the Internet. Some of the content searched may be locally stored and indexed, while other content may require that a connection be made to a server or external third-party web services. Moreover, a server may crawl and pull in content from a web-based system and augment to the results once the content is vetted, moderated and analyzed.

Other tools available to the student to assist in their learning and integration within the core app 40 may include integrated tutoring, shared docs, notes, math calculators and graphing tools, game-based learning apps, plagiarism checkers, essay creation assist tools, content apps and web portals, and quizzes. Integration between the core app and any additional apps or features may be done using shared key authentication or via common standards, i.e. IMS LTI standards, when applicable to the app. Preferably integration leverages interoperability best practices and standards where applicable. Shared key authentication may allow the user to go from one app to another, including the core app, without the need to login to the other app as they have already logged into the core app. This may work for users where the other apps are using the same shared authentication key.

The system 10 may follow Universal Design principles and leverage the Universal Design for Learning (UDL) framework to accommodate a variety of types of learners. However, there may be some alternatives in design to consider for the different age groups, such as early elementary, elementary, mid-school, high school, post-secondary, and others. Certain feature such as login may be simplified for earlier grades when applicable.

The system 10 may contain a student portfolio that is associated with each student and may be automatically updated throughout their learning journey through the system. This may be stored at the educational institute or elsewhere so that it can be accessed or updated each year, even if the user's tablet is replaced or updated.

The core app 40 may allow students to develop an avatar, such as a custom digital character, emoji, image, that can be updated for student engagement, such as through the messaging section.

The system 10 may include an educator-specific app with the same or similar features as the student core app but additional features, such as for administration, management, moderation, teaching, and grading. The system may modify the ability to have flexibility on what features the educator would like to enable or disable. For example, social sharing could be disabled. The educator may, through their educator specific app, modify the features available in the student app as specific to the educator's class or program.

Specific features that the educator, the teacher/instructor may have in the app include grading. The feature may include a gradebook to record grades of students, BLM (black line masters), teacher resources, answer keys, teacher aids, and other types of content targeted for educators, reporting, administration, teacher notes, and the ability to purchase other educator content via an educator marketplace. In addition, some senior educators and admins may have access to additional features such as customizable reporting dashboards at a macro level.

The system may include a parent version of the app, that may be used by parents, or other family members of the student. The app, or web or mobile app based may have may have fewer features than the student core app. It may include perpetual access to subscribed to/purchased content, when applicable. Specific features for the parent app may include messaging the teacher, class updates and notifications, ability to customize how they want to receive notifications, content.

The system may include the ability to provide additional content to students for practice and preparation for exams. Such additional content may include the EQAO package, CCAT, workbook package, practice specific math sections, recommendations accessed via subscription. Some content may be available at additional cost or only through special programs or restricted number of users.

Content 60 may be made available on the core app 40, as determined during the initial setup process. Content 60 may be categorized into three main section: 1) core textbook content, 2) Practice or Assessment (formative, summative, high-stakes) 3) Content supporting tools. Additional content may be available through subscription.

Taking textbook or other educational content that is broken up into learning objects (topics) and provided in a variety of formats best rendered in a digital solution. The content may be offered through a rich and immersive reader to support different types of learning, such as reading, text to speech, and other accessible considerations.

For example, the content may be provided as engaging and immersive content. Topics that can be searched and broken down into bite size chunks based on concepts and topics. The topics may include videos, audio, images and text, and may include augmented reality blending real world with digital using markers, and include other interactive elements within the content.

The core app 40 may include the ability for the user to access content when the mobile device is connected and when it is not connected. All content may be pre-installed during the initial setup on the device. Updates may be done when the mobile device is connected to a computer network, such as over wifi. Some content, such as rich media (photos, audio and video) may not be available offline and may only be accessible while online and the content can be retrieved as needed from a server. This may be done to conserve digital storage space on the mobile device.

Some or all of the content available through the app may be protected through Digital Rights Management (DRM) with print and download restrictions that may be configurable depending on the user and the specific content. Restrictions may limit the option to make copies of the material beyond what may be authorized, such as by the owner or license of the content.

The core app 40 may include the functionality for a user to create user-generated content, such as by annotating, highlighting and taking notes, using for example a stylus, keyboard, mouse or other interactive interface. The user-generated content may be typed or handwritten or drawn. The user-generated content, such as annotations, highlights and notes may be saved and persistent within the system in association with the user making the user-generated content. The system may include citation information for content, including authors, illustrator, publisher, place of publication, series, series authors, series copyright: year, and other credits. The citation information may be automatically incorporated into user-generated content.

The core app 40 may have the ability to control access to the content based on an access length defined during initial setup. For example, the core app may restrict access to a specific course material to only the period of time when the student is taking the course, a portion of a course, or has the device, or it may offer access to the content for the length of title, or perpetual access.

The core app 40 may include the ability for users to bookmark certain areas of the content, so the content can be more readily accessible later and share the bookmarks with others.

The system 10 may include an accessible application and content based on accessibility legislation, standards and accessibility best practices. Such accessibility guidelines may apply to the user experience, design, development and universal considerations (UDL framework) of the solution.

The system 10 may include the ability to support different formats of the digital content. Content such as epub3, html, pdf, immersive templates/widgets. Such content may be loaded through the content management system and displayed in the core app.

The core app 40 may include the ability to print the content based on the configured digital rights management and initial setup.

The core app 40 may include content to encourage practice of the subject matter. The practice may be formative or summative. The core app may provide a gradeable assessment such as summative or high stakes. This may include questions and answer assessments such as multiple choice, true and false, fill in the blank, drag and drop, drill and kill, competitive (student vs. students or student vs. the teacher), math formula type questions, open response/short answer, essay, drawing type or other interactive questions.

The system 10 feature may also include the display of questions that apply towards assessments where the results may be returned in real-time and integrated with the institution gradebook. The practice or assessment features may be integrated with the digital version of the textbook content to access the practice or assessment seamlessly from the mobile interface.

Depending on the question type, the assessment may be auto-graded where the grading of the assessment is recorded by the teacher in the gradebook (manually or automated) via integration with the institution's gradebook solution. Rich visualizations may be provided around the gradebook results which are accessible by the appropriate users according to privacy laws, and anonymous to others. For example a student may be able to see their score in the context of the class results without disclosing the specific scores of other students.

The core app 40 may include gamification elements built into the practice and assessments. Some gamification elements may include points/rewards and a leaderboard. The feature may include the ability to use points to unlock certain features or elements, or progression of an avatar. Active rewards may include points or ‘gold’ earned that can be used to unlock certain features as well as passive rewards such as badging for certain achievements. This may include competitive elements of practice, such as challenging friends and head-to-head play.

The system 10 may include adaptive practice based on various criteria including but not limited to whether answered correctly or not, time spent, other factors/similar questions, algorithmic, A.I. based functionality.

A gradebook feature may include the ability to record grades, either automatically or manually. The gradebook may integrate with Student Information System and Gradebook systems such as PowerSchool or others.

Content tools may be provided that assist with the content and learning such as graphical representations of visualization aids, such as base-10 blocks, and other data visualization.

A notepad or a scratchpad feature may be provided that allows user to write down notes, integrate multimedia (audio, images, video), or do other work that may previously be written in a physical notebook or on paper. The feature may include ability to type, hand write or draw using a stylus, touch screen or other interface. The interface may provide different types of backgrounds to write on, such clear, lined, graph, and may be customize based on preferences.

Some other features that may be included in the core app 40 are a calculator features and functions to assist with the work, a dictionary to provide spelling and word definitions, and flashcards to assist with studying.

In some embodiments, artificial intelligence or machine learning (AI) 36 may be used to analyze learning analytics such as content usage, pedagogy, other data and provide recommendations on content, assessments, practice, lesson planning, further adaptiveness, personalization & other guidance specific to the user. For example, AI features 36 may recommend lesson planning, and a content recommendation engine may suggest that students get a superior grade when taught content in a specific order, grade and material

In addition, AI bots may be used to message, answer questions, communicate, recommend and assist in the users learning.

Other studying tools to support learning and interaction with the content may include collaboration with others, guides, hints, and study organization.

The system 10 may include server software 34 to provide some or all of the services. Such services may include backend processes, tools and administrative functionality. This may include backup, storage, setup, management and support. Cloud-based servers may be used to store content or provide some or all of these features. Personal data may be stored or backed up to the cloud storage systems.

The core app 40, and the server software 34 may directly integrate with SIS 52 and MDM/MAM 50 and provide access to content. The system may provide single-sign-on options using key integration. Management tools, services and functions may be provided by the solution.

An institution's student information system (SIS) 52 may be integrated to provide student info, such as a unique student ID, teacher and instructor info, course, class and program info. The information from the SIS 52, may be loaded on the core app 40 and on the mobile interfaces 30 so that students have access to the resources they need to support their learning. For setup, this may include the rostering of students, teachers and classrooms, courses. Continued integration may be set up with the SIS 52 to synchronize grades and other data.

A Mobile Device Management (MDM) solution 50 may be used to set up devices for all the users and provide additional management and configuration features on the device.

Mobile interfaces 30 may be redeployed to other students, teachers and users once the duration for the class or course is complete or if the user changes programs.

The system 10 may securely store information, particularly personal information using encryption and having secure and restricted access to the information. The information may be tracked for audit control and to restrict its movement within the system. The storage of personally identifiable information (PII) may be stored separately from other data based on regional, institution and legal considerations.

A classroom management system 54, may be included within the MDM/MAM 50, or as an additional management system. The classroom management system 54 may include features such as monitoring students and classroom screens, project or mirror the teacher's screen or particular student screen to the rest of class (such as with additional hardware 32), communicate with the classroom, such as through a message broadcast, audio, video, remove distractions, such as by blanking out screens or limiting access to websites or apps, assess progress via voting, polling, questionnaire, assessments, technology usage reporting, and inventory management.

App services may need to communicate between the apps 40 42 and backend servers 34 or cloud in order to provide content, learning analytics, and other data. Content updates may be supported through application services and pushed out to devices. Learning Analytics data may be stored and reported on, such as usage, time on task, student progress and assessments.

Single Sign On (SSO) or similar account information, if needed to re-use credentials and access existing content on educator or providers platforms may be required. SSO may be implemented using token sharing or through an ability to share using Google, Facebook or other platform's login info (via secure key) instead of having to create a new account. Open Auth, Open ID, LTI, other shared user cred standards may be used.

For content generation and for user-generated content, the system may integrate with one or more WYSIWYG (what you see is what you get) editors for assignments, notes and other content such as Microsoft Office or Google Docs.

Data, notes, and user-generated content may be backed up and synchronized from local app storage to server or cloud-based storage when the user is online

The core app 40 may include email and PDF features. Email may be used to send and receive notifications, documents and other content. Media conversion may be completed at the app, servers or cloud services to convert one format to another, where applicable, such as to reduce bandwidth or storage, or to improve rendering.

The system 10 may provide an administrative app 44 to provide a series of tools and functions for administrators. The administrator app 44 may be implemented as website or web portal. Such functions may include setup of devices, keys, content, and testing. Administrators may be provide with different access levels based on their role. The administrator app may include the ability to create unique keys for the different users of the system, and to gain access to the apps and establish the classroom, course and institution connections. The administrator app may allow key generation for students, parents, educators to establish institution connections and to connect with specific classroom/course.

Guides may be provided to allow students and other users to set up their mobile interfaces and start accessing the content and features. Such guides may be provided electronically on the mobile interfaces 30 or in paper.

The system 10 may provide reports to students, instructors, senior educators, administrators and staff, and parents. Access controls for the reports may be set up to store and view data based on privacy laws and may appear as anonymous to some users, but visible and non-anonymous to the appropriate users.

The system 10 may provide several administrative tools to set up, configure, manage, deploy, and test the system. The administrative tools may include user management, including adding and remove users, changing user details, access controls and access keys.

Administrative tools may include features for loading content for or from content providers. Features may include the ability for educators to edit how they would like to use the content. Content may come from online educational resources (OER), educational publishers, educators, and a variety of other sources and loaded to the master content repository, or LOR (learning object repository).

Educators may be able to request certain content, preview content created by other educators which they can obtain, use and/or purchase. Such purchase may allow the educator that developed the content to receive a payment, or other recognition.

The administrative features may include features for ingestion and creation of content using a content management system.

Administrative features may include guided interfaces, such as wizards for content providers. Such features may include options available to enhance content, leverage additional features. The administrative features may include reviewing content from content providers prior to pushing available to customers.

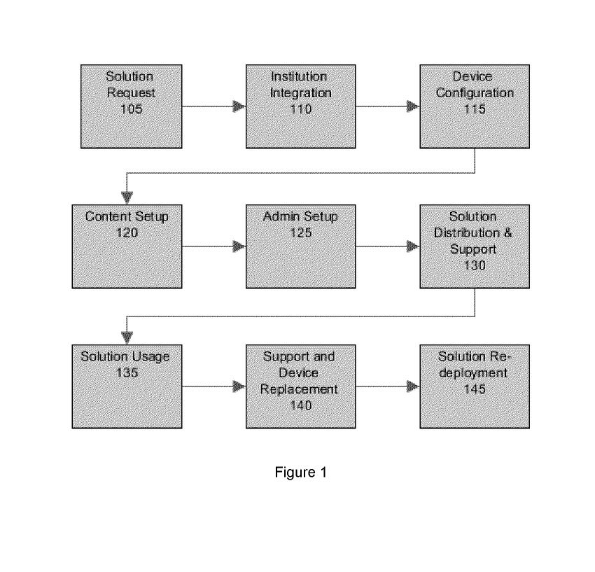

With reference to FIG. 1, the following tracks some of the steps of setting up and deploying the system.

With reference to step 105, a provider may receive a request from an institution or school. The request preferably includes hardware details for the mobile interface 30 (iOS, Android, Windows, Chromebook or other mobile device) and other operating system and software/app needs such as device image/setup specs, configuration, modification, restrictions, preferences, access and permissions, accessibility, and security.

With reference to step 110, the provider integrates with school/institution Student Information System (SIS), Gradebook system (e.g. PowerSchool). The integration may occur via feed, script, real-time service or manually through admin tool if provided. The provider may use MDM, MAM, or classroom management tools for device and user integration. User integration may occur via user ID or other unique identifier(s) as provided by the SIS or other source. Further planning and testing with institution IT in their current environment may be required.

In some cases, integration with the institution's systems may not be desired or the institution may not have an MDM 50/MAM/Classroom Management system 54 in place. For this instance, a ‘bring your own device’ (BYOD) style device management may be deployed. In this setup, there may be minimal or no dependency on the institution's infrastructure or IT team other than providing an internet connection, preferably wireless, accept the provider's app/software within the institution's LMS or education systems, such as D2L, Moodle, Google Marketplace, in order to push/pull information to/from it. Changes may be required to allow certain websites to have access over the network, and open certain ports. These devices providing the mobile interface may be set up and managed by the provider including using any MDM/MAM/Classroom Management or similar like services. These services may be used for remote patching, providing updates, monitoring, mirroring, sending notifications, pushing shortcuts, setting restrictions, managing device inventory, monitoring device usage, device & application troubleshooting and support, device replacement.

A hybrid model of integration may occur where some institution systems are integrated and some are leveraged from the provider.

With reference to step 115, the provider may configure the mobile interfaces 30 or devices, based on the hardware, OS and software/app specifications. and may also assist in setting up with the institutions management tools such as their Enterprise Mobile Management (EMM) Suite: Mobile Device Management (MDM) (e.g. Apple MDM, Microsoft MDM, VMWare MDM, Cisco MDM, other), Mobile Application Management (MAM), Classroom Management Software, and other institution education systems, as required. In cases where the institution already has devices, the application software, content and other services may be configured on these devices without the need to deploy new hardware.

With reference to step 120, the provider may allow content providers and educators the option to integrate content through a guided content management system based on the education institution request. Content may be pre-loaded on the device or downloadable from the cloud. Other content can be loaded and available through subscription.

With reference to step 125, the provider may set up each of the mobile devices prior to deployment based on a set of pre-requisites for the different user types (student, educator, admin), configuring the core app, additional OS/software/license setup, integrate user access on the device (if requested) and generate access keys on behalf of the institution (when required). Also, the provider may prepare and distribute starter package (for example, day one printouts with keys, guides, faqs, or other references) for the users, whether educator, student, or parent.

With reference to step 130, the provider may distributes starter packages and hardware/tablets (other hardware if requested) to the educator. The provider may provide assistance and troubleshooting in the setup as requested.

With reference to step 135, users, whether educators, students, or parents collaborate and leverage the app for the prescribed duration. Users may have the option to install a ‘lite/personal’ version of the app on their personal device (such as by downloading from the app store) and associate with core app/account via an identification key.

With reference to step 140, customer support may be made available to users leveraging the solution where issues can be logged via online form, phone, email and which goes into a ticketing system. In the event there is a device failure or issue that cannot be resolved, a replacement device may be delivered. Moreover, several additional devices may be provided onsite for a quick swap-out if required.

With reference to step 145, the provider retrieves and re-deploys the mobile devices once prescribed class/course/program duration is complete. The devices may be reused with regard to a further system deployment, step 1. If the devices have not been provided by the provider and belong to the institution, the re-deployment and updates may be managed by the application software and services.

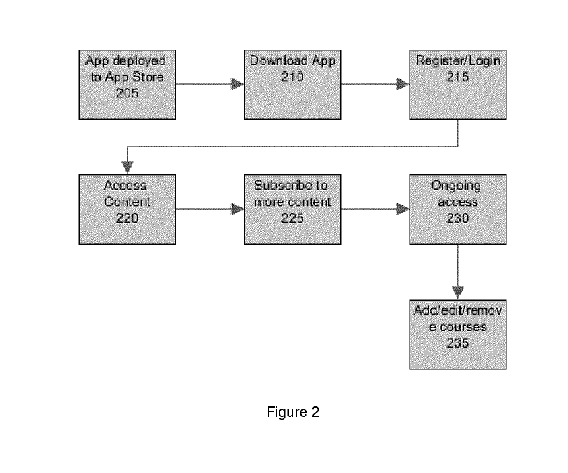

With reference to FIG. 2, the deployment of a personal device is described.

With reference to step 205, an app, such as the core app 40, may be published or uploaded to an accessible location, such as to an app store or web portal. An app store may include app stores from Apple, Google, Microsoft, or Chrome for the student, parent, student, educator, family, or other user version of the app. The app may instead of or in addition to be accessible on the web via web app/web site/web portal. Access to the accessible location may be restricted based on access location or access credentials.

With reference to step 210, the app may be downloaded from the accessible location. The app may be the core app 40, an educator version of the app, an administrator version of the app, or a lite/personal version 42 of the app.

The user, whether student, parent, educator, other may download the app on their personal mobile interface 30, such as a tablet, smartphone, laptop or other device, or accesses it via a web portal.

With reference to step 215, the user may register with a new account or logs in with an existing account into the app 40 on their mobile interface 30. The app 40 may allow the user to leverage an existing account such as from Google, Facebook, MS, or other through common authentication standards. The user may login with an existing account provided by their institution.

With reference to step 220, the user may access content available through the app 40, and may browse, search and find content or practice they would like to use. The app 40 may provide some content out of the box, without requiring further content to be downloaded.

With reference to step 225, the app or web portal may provide the user the option to subscribe, or download to provide additional content and features.

With reference to step 230, the user may also have the option to connect with an existing education institution class/course (if the solution has been deployed with that institution) and synchronize accounts and data. This may done through an access key provided by the provider to the user, whether educator, students or parents. Once the user connects with their class/course setup, they get access to the content the education institution has available, or if they are already subscribed to the lite/personal app 42 or web portal, they would receive a discount to their subscription. Data may remain synchronized between the personal/lite 40 and core (institution) app 40.

Also with reference to step 230, the user may have persistent access to their student data/content within an electronic portfolio, such as an electronic notebook, or profile and other content they have subscribed to/purchased based on their subscription term. This portfolio may exist as part of existing cloud-based account, such as being integrated with Google-drive, docs, and numbers. This app/web portal and data may stay accessible to them throughout their learning journey.

With reference to step 235, the student may have the ability to add, edit or remove an education institution's class/course as they progress through their learning journey, or subscribe/un-subscribe as needed.

### Content Ingestion Flow

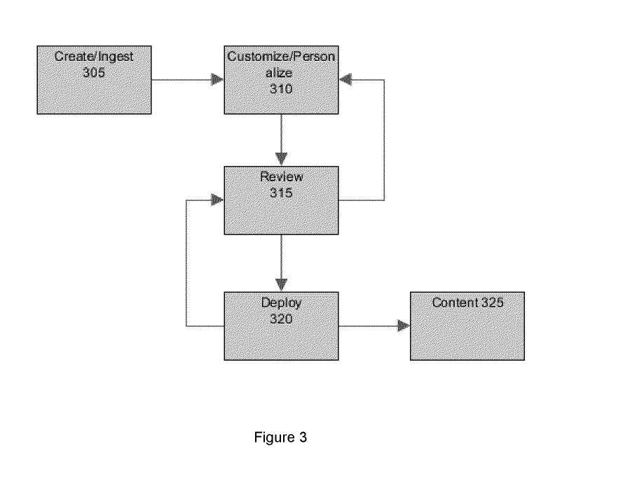

The following description of content ingestion flow is with reference to FIG. 3.

With reference to step 305, the system 10 may provide for the ingestion, creation, viewing, updating, removing, selling and collaborating on educational content 60. The content 60 may be learning objects, assignments, assessments or other modules. The content may be maintained in a content management system and access and permitted activity based on the content provider, educators, admin's role and authorized access. These activities may include importing from design/document formats, such as InDesign, into the system. The activities may also including setting up the appropriate meta-data and tagging, converting to various output formats, defining DRM restrictions, defining access length/subscription, setting ecommerce considerations such saleable content and the marketplace for educators, and storing and managing the assets and content data.

A content management system (CMS) 38 may be deployed on server(s) 34, or cloud-based and accessible through web, mobile or other app interfaces. The CMS 30 may include a data and content storage mechanism via a database/or storage and (asset) server/storage. Content 60 may be published to the master repository 39 based on scheduled deployments or as requested. DRM rules may be associated with the content and may be enforced through the business logic/services layer at the time of request/usage from the user.

With reference to step 310, content providers, educators, admins can customize the content 60, including by being guided through a process/wizard. The content creators may leverage templates and widgets, features, and select formats. Widgets may be re-usable code blocks/interactions/animations to render and display content in different ways. The content may be personalized based on the educator, students or class. Content may be modified or customized to provide specific support for mobile and web apps.

With reference to step 315, the content 60 may be reviewed in a test environment with the ability to go to step 310 and further customize.

With reference to step 320, the content 60 may be deployed for use via the app 40, website or portal. The content 60 may be accessed through a server side requests via services layer. The requests may pull from the master repository 39, or other location where the content is stored such as in a database, on servers or in the cloud with the option for the user to download locally on the device within the app for offline storage. The data may be stored on local device storage, preferably securely. Moreover, content may be stored on the mobile interface during the initial setup, such as at 120, and further updates to the entire app or content may be updated through app store updates or other means to transfer content to the mobile interface.

With reference to step 325, once the content 60 is deployed, it is included in a master repository 39, such as a learning object repository or LOR. For educators and students of a particular program/course, the content may be personalized and available for their use prior to the first day of class. In addition, other content may be available and can be subscribed to by the user at any time. This may include providing this content to users that may not have the education institution deployment and only have the personal/lite app installed.

The system may analyzes the needs and trends of the user and provides recommendations based on all aspects of content usage such as the type of content used, or the sequence the content is leveraged, including the pedagogy order, all which result in the best outcomes for educators and students.

### System Architecture

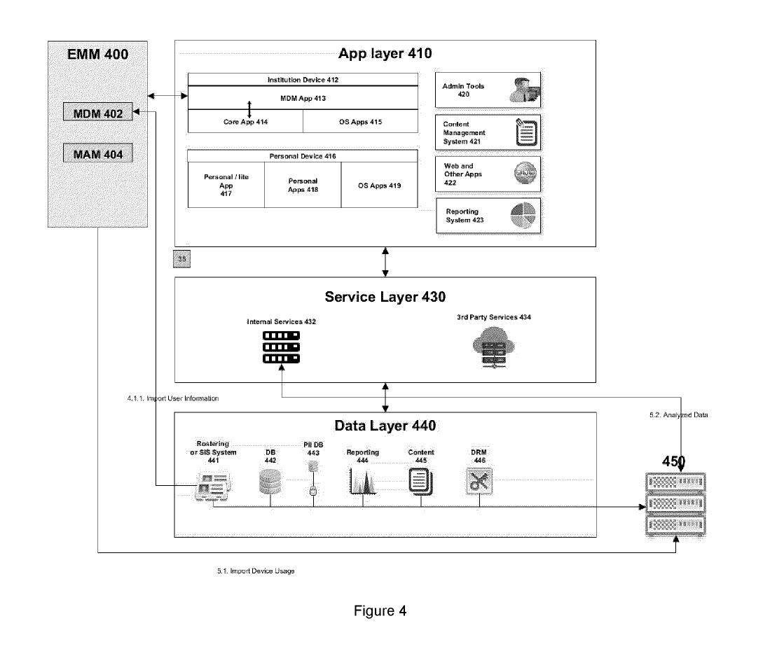

With reference to FIG. 4, the system may have several components to its overall architecture. This architecture may be implemented on the core app 40, on one or more servers 34, a cloud hosted system or a combination.

Enterprise mobile management (EMM) may be used particularly if institution issues devices to be used as the mobile interface 30 that can be manage them with an EMM system 400, or similar management services may be provided by the provider. A mobile device management component (MDM) 402 may be used by IT administrators or the Provider to manage, monitor and manage devices issued to users. A user management module with the MDM 402 may be used to add and remove permission to the app depending on the role. User and roles may be entered manually or imported automatically from rostering or an SIS system.

Mobile application management software (MAM) 404 and services, or similar may be used by the provider for provisioning and controlling access to internally developed and commercially available apps and content. The MAM 404 may provide features to install, monitor, upgrade or delete the core app 40 or lite app 42

A MAM dashboard feature of the MAM 404 may be used by tech. administrator, or an alternate dashboard from provider. For app management, depending on user role and group, institution may deploy private and public apps to the device, or if managed by provider, deployment of apps, updates, patches handled by similar services.

The app layer 410 generally relates to the functionality of the core app 40 both at the mobile interface 30 and at one or more servers 34, either physically onsite or cloud-based.

An institution provided device 412 being used as the mobile interface 30 may be issued to user by the institution and controlled by institution or provider EMM 400/or similar management system. The institution device 412 may include an MDM app 413 that communicates with the institution's MDM 402 or alternate provider solution that may be downloaded and allow access to the device 412.

The core app 414 may be installed on the device 412 by MDM app 413 or installed directly on the device image and managed through a service from the provider. This app 414 itself may be controlled by the institution MDM 402, or provider service. MDM 402 or similar service may send a message to install the app or install it automatically in the device.

Some default apps 415 may be pre-installed on the device. Some of these may come with the image pre-setup on the device based on the institution specs. They may not be affected or controlled by the MDM.

For personal devices 416, such as in a bring-your-own device environment, may not be controlled by institution MDM 402. On the person device 416, a core app 40, or a personal/lite app 417 may be installed. User personal devices may be allowed to download and install a lite version of the app or access via web portal. The lite app may have more limited functionality.

The lite app 42 may not interfere with the user's personal apps 418 or the built in apps of the operating system 419 so the user can continue to use these apps without fear of losing privacy of their data.

Instructors, educators and institution administrators may access administrative tools 420. Content Providers, Educators may ingest, access and manage content through the content management system 421.

There may be web-based apps 422 as well as other apps with similar features to the core or lite app to allow for greater accessibility. Other apps for administration, may also be provided through the web.

Different reports may available to different level of management, educators, employers, students and parents through a reporting system 423. The service layer may provide services used by the apps and the websites or web portals.

The app, wither core, lite or administrative, may access services through a service layer 430. The service layer 430 may consist of internal services 432 provided by the provider or institution and third-party services 434. The provider and institution may provide internal services 432 that are available to the app. Some of these services may only be available through as secure connection, such as through a VPN. These services may include services used for administration of the solution, some to sync SIS/roster information, some to sync gradebook information, and other functions that may involve the communication of sensitive or personal content.

The app may use third-party services 434 to provide additional features and content. Integration with 3rd party services such as Google Drive, Google classroom, MS classroom/teams, Dropbox. Access to third-party services may using authentication methods like Open ID, Oath, Active AD, LTI, or other systems. Institutions may create a new ID for students or allow them to share institution ID to access these services.

A data layer 440 may maintain the underlying content and other data used to support the services. The data layer may be maintained on cloud-based servers for storage. The storage may be SQL, NoSQL databases, big data databases or other storage. The data layer may be separated out and store PII separately, for example stored locally depending on the region.

Rostering or SIS System 441 may contain the user information from all institution system. It may include usernames, passwords and what classes/course a student is enrolled. Some institutions may not provide this information or only provide a subset. This may also include gradebook details/integration.

An institution may want to use SIS or Rostering information in the EMM 400, such as existing employee definitions for administrators, educators. Otherwise Institution may create new user and roles in the MDM 402.

One or more databases 442 may contain information about the users except for their identity information. Information may be linked using a system internal identifier.

PII information may be stored separately in a database 443. Student's personal information and data may be regionally and securely stored based on privacy laws. Some student records or information, such as related to special education needs may not be stored at all until prior consent of institution is obtained.

The data and service layer may generate and store reports and analytics 444 for specific users. For example, these reports may include time spent reviewing specific content, time spent to answer a question, total correct responses, total incorrect responses, amount of times to answer a question correctly, common search terms or topics browsed, relationship or pattern of content usage, total messages logged, patterns within the messages, assessment and practice total time spent, scores & results.

Content 445 may be maintained by the content layer and interact with the service lawyer. The content 60 may include the content objects, HTML, CSS and Javascript, ePubs, pdfs, custom content, and other contents that is available. The content may be broken up by topics, strands, practice or assessment questions. The content objects may be short sections of content that can be interconnected in a non-linear manner. Unlike a book which is intended to be consumed from the first page to the end, a user can navigate from one content object to another object, such as based on their own preferences, suggested related objects, mind-map, type of objects, filters, searching, the educator or from recommendations from the analysis module. The content objects may be stored as nodes in a graph data structure. The content object nodes may be interconnected based on theme, issue, chronology, author, other meta-data, input from an educator, and recommendations from the analysis module. The content objects may be arranged like a mind-map with a hierarchical structure showing relationships among content objects, such as based on common concepts or themes. The content objects may be linked in the data structure to related content objects based on the common concepts or themes so that users can navigate from one content object to another without being restricted to linear navigation.

Digital right management 446 for publishers, provider, other content providers requiring content restrictions may also be maintained by the data layer.

An analysis module 450, such as using artificial intelligence (AI) or big data machine learning module may also be included in the system. This module may be a combination of servers, databases, storage, logic, scripts, processes, algorithms, apps, neural networks, and analytics that consume data from the systems and 3rd party systems. This module may analyze the data and create a set of results that may be incorporated into reports and to further personalize and guide the user based on AI generated trends, recommendations. The analysis module may identify content, such as content objects, that provide superior results for students learning, such as based on assessment results. The pedagogy of the educators such as the use, time spent and order of modules, content objects or assessments may be tracked as well as the outcomes of the students. As a result, the superior content objects may be recommended by the analysis module to future students when selecting topics.

EMM 400 may also collect usage information about device and deployed apps and content with MDM 402 and to also be leveraged for the analysis module 450 to analysis through an application programming interface (API). Analyzed data by analysis module may be available to reporting system 444.

### Physical Systems

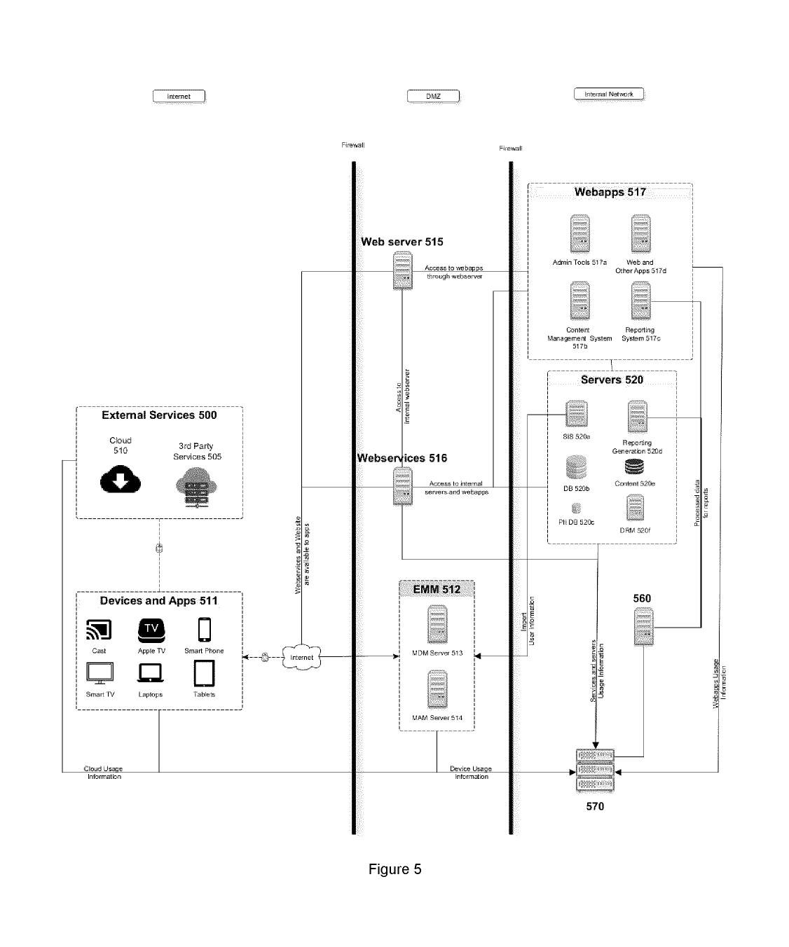

The following is with reference to FIG. 5 showing physical components of an embodiment.

The core app 40 may use external services 500, including third-party services 505, cloud services 510, enterprise vendors and apps. The cloud services may include Google Drive, Google classroom, MS classroom, Dropbox.

Third-party services 500 may use Authentication Methods like Open ID, Oauth, Active Directory, Custom authentication. Institutions may create a new ID for students or allow them to share institution ID to access these services.

A mobile interface 30 may be provided on a variety of tablets, smartphones, laptops and other mobile devices. Other hardware and software 32 may be used for streaming, mirroring, and presentation purposes. Devices and apps 511 encompass the software and hardware used by the users to interface with the system.

A variety of services that apps and consoles will use may be accessible through web services 516 over connections over the Internet. The provider and institution may make other additional services available to the core app 30. Some of these may only be available through VPN (e.g. private services used by admin tools).

There may be some functionalities, services, and tools available through websites, web portals or web apps.

If institution issues devices to users then the devices may be managed with an EMM 512, such as MDM 513 or MAM 514 services operating on one or more servers. Alternatively, the devices may be managed by some other type of mobile device management system. A mobile application management software and services may provide provisioning and controlling access to internally developed and commercially available apps.

Webapps 517 are a variety of web application that may be accessed through a web server 515 accessible from browser software operating on devices 511, such as the mobile interface 30. The web apps may be implemented as microservices with each service providing a particular functionality or API (application program interface), and may be independent of other services. These applications may include administrative tools 517a for use by the provider admin, institution admin and system admin tools. These applications may also contain user-accessible tools.

A content Management system 517b may contain the institution and educator content administration tools. A reporting system 517c may contain on demand real-time reporting. These reports may be generated from analysis modules 560 or from internal data servers 570. These reports may be available through web or device applications/interfaces. Other functional may be provided from other web apps 517d.

Cloud-based or local hosted servers 520 may hold the data such as in databases 520b used for the system.

A rostering or SIS System 520a may contain user information from all institution systems. It may include user data such as user id, other user attributes, class/course/program they are enrolled into.

Information about a user except their identity information may be stored with user personal information are linked using system internal ID's. A PII DB 520c or storage may be used if an institution may decide to store student's personal identifiable information in an independent environment/data server. The information in these servers may be tokenized and encrypted in accordance to Federal, Provincial, and Institution privacy policies.

Generated and stored reports and analytics for specific use may be maintained for example, student progress reports, usage report, ability to generate and store monthly reports separately in a server 520d or as part of other storage.

The educational content may be maintained in content objects, bite-size content, multimedia files, ePub files, pdfs, HTML/CSS, templates, other available formats and other content that is available to institutions and users. Digital right management 520f for the provider and other content providers content may be kept in association with the content. The content 60 may be stored in a content store, such as a content management system 517b, a content server 520e, either hosted or in the cloud.

Separate servers or cloud-based systems may be used for an analysis module 560 and data storage 520. The analysis module 560 may collect usage information from external servers and services related to users and apps, including logging data and store the data, such as in storage 570. Apps specific usage information may also be monitored and analyzed for example, which UI element or elements of the app was used. Device usage information from information that may be collected by the EMM 512 including device and deployed apps and content with MDM. Usage information related to web services and servers may also be kept and analyzed. Analyzed data by analysis module 560 may be available to reporting system. These servers may analyze all data and create a set of results to be consumed by the reporting system and the administrators. These systems may provide recommendations based on learning algorithms.

### Institution Device Single Sign On (SSO) Setup & Authentication

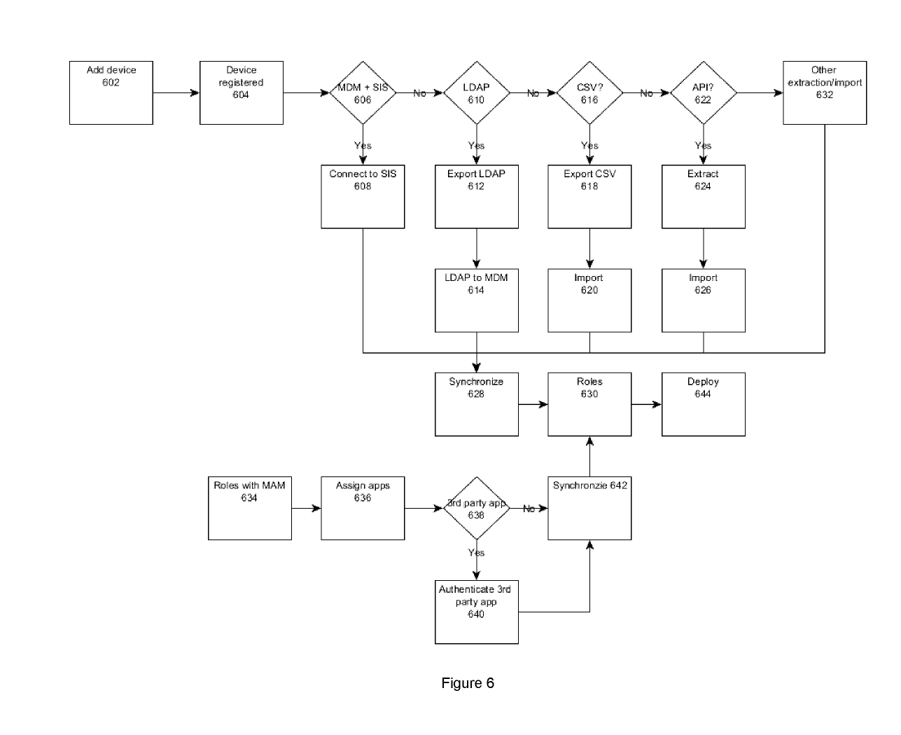

With reference to FIG. 6, the following describes a process for device setup and authentication.

Device authentication may be used to provide an additional layer of security on the network by ensuring only authenticated devices can be used on the network. This additional layer available through the MDM system (via the administration), prevents non-authorized devices or users the ability to leverage the institution setup device/app.

Additional steps may be taken to automatically create user accounts and authenticate a user to a given device. This process may involve 2 phases. The first phase is to integrate the user's information into the Mobile Device Management (MDM) system and create user credentials and passwords. The second phase is to authenticate the user's credentials on a specific device.

With reference to 602, the Administrator may create a security policy in the MDM Admin Tool. This policy may include only specific devices to be authenticated within the network or a group of devices. The device may be added with reference to a specific device serial number or unique identifier. With reference to 604, if the security policy includes device authentication, then each device may be registered using a unique identifier, such as the serial number or MAC address (WiFi Address), such as specified in the MDM Admin Tool.

With reference to 606, if an institution has a student information system that is to be integrated, then the SIS may be integrated into the MDM, if the MDM has the available module. With reference to 608, the Administrator may log into the MDM Admin Tool and authenticates with the SIS.

With reference to 610, 612 and 614, if the institution uses a rostering system that is integrated to an LDAP Directory (AD), and the MDM also use an LDAP Directory then the LDAP Directory can be used to integrate student information. If the school's or school board's LDAP Directory in the cloud, that is, is the school or school boards using Cloud LDAP, then step 6 can be skipped. If not, then the users that will require access to an MDM device will need to have their accounts migrated to Cloud LDAP.

With reference to 614, once the users have been successfully migrated to Cloud LDAP, then the LDAP Directory can be integrated into the MDM. The specific steps to provide the integration may depend on the MDM being used.

If SIS and AD integration cannot be used, but the rostering system has the ability to export the necessary student information to a CSV file 616, and the MDM has the ability to import a CSV file then CSV files integration can be used. If not, then another solution may need to be developed.

With reference to 618, the Administrator may log into the rostering system and exports the specified fields to a CSV file. With reference to 620, the Administrator may log into the MDM Admin Tool and follows the process to import the CSV file.

The SIS may also include an API (application program interface) 622. If it does, then the API may be used to extract user information using a software program 624. The software program may then import 626 the user information into the MDM.

With reference to 632, if there isn't a method to integrated the user data with the MDM, then a custom solution may be required using global standards such as IMS Global's Learning Information Services (LIS) specification or manually transcribing the information into the MDM.

Once the authentication is successful, the Administrator selects the information to synchronize, with reference to 628. With reference to 630, once the synchronization process completes successfully, the Administrator then assigns the users into various roles. For example, users may be educators or students. Passwords may also be initiated for the users. The devices may then be deployed, with reference to 644.

The MDM may either use the credentials in the SIS, LDAP Directory, CSV, or API Services to create the username or the MDM can auto-generate the username. The Administrator may also assign passwords to each user once the usernames have been created, preferably using a strong randomization feature.

With reference to 634, the administrator may define the various roles for each application then create these roles in the Mobile Applications Management (MAM) Server using the Admin Tool. The administrator may assign the various apps and content to each MAM role, with reference to 636.

Once the MAM roles have been created that identifies the secure apps available through the EMM, these roles need to be mapped or synched to the roles previously created in the MDM which identifies the device and user, with reference to 642. For example, this sets up the user/device relationship with the apps they have access to.

With reference to 638, third-party apps may require MAM authentication and synchronization with the MDM data, with reference to 640. This may use a SSO to authenticate with the 3^{rd} party app.

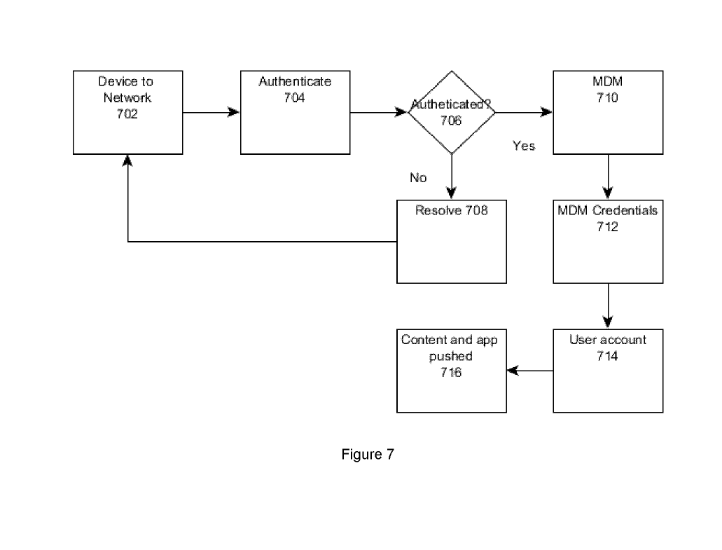

With reference FIG. 7, at 702, for network authentication, the Administrator may connect the device to the school's network, such as the wireless network. With reference to 704, the device registers with the MDM. With reference to 706, if the device is approved to be used with the school's wireless network, the device is authenticated. Otherwise, the administrator may need to resolve the issue, with reference to 708.

Once the device has been successfully authenticated with the wireless network, the Apps on the device may need to be authenticated for use. This may be accomplished by installing the MDM App and authenticating the user's account on the device. With reference to 710, the administrator may install the MDM App to get the full benefit of the Apps and Content provided by the school or school board.

With reference to 712, the administrator enters the user's credentials into the App. The App authenticates the credentials by connecting to the MDM system. MDM systems authenticates the user's credentials and provides feedback to the App. The App uses the approved credentials to provide user access to the App's content.

With reference to 714, the device may use the authenticated user credentials to synchronize the device to the user and allow the user access to other app within the device. The MDM may create a student folder to keep information synchronized on the device, if the user is allowed to use multiple devices.

With reference to 716, the MDM App may connect to the MAM Server to push available apps and content to the user.

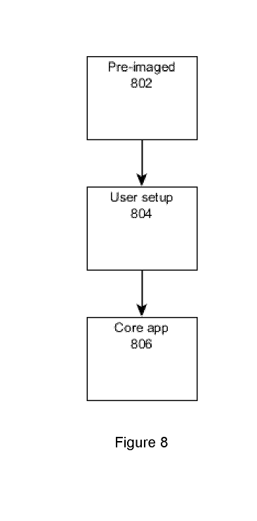

With reference to FIG. 8, the following describes a process for device setup and authentication without the use of MDM, and alternatively leveraging enterprise SSO.

With reference to 802, devices to be used for the mobile interface 30 may be pre-imaged and set up based on institution specs. With reference to 804, the user may set up the device account, or the account is pre-configured by admin, when initially receiving the device with the education institution account information. For example the username/email & password may be used. The password may be biometric data such as finger print, eye scan, face scan, or alternate means of sign-on, especially for primary school students. Leveraging the SSO institution education account, for example SSO for G Suite or alternate enterprise SSO system, the SSO token/identifier is used to access the core app (and other apps directly) without having to log in again.

With reference to 806, the user may see the core app and may have other apps on their home screen upon device login. When selecting the core app the user may be automatically signed in and taken to the app home screen using the SSO token/identifier from the initial device login

For other apps accessible from the home screen, some may require a login with the same SSO may be carried across, or others apps may not require a login.

Once the user is within the core app, they may be able to access other third-party apps from within it by re-using the same SSO token without having to log in again or leveraging alternate SSO standards such as LTI and OAuth.

### Integrated Content and Practice/Assessment

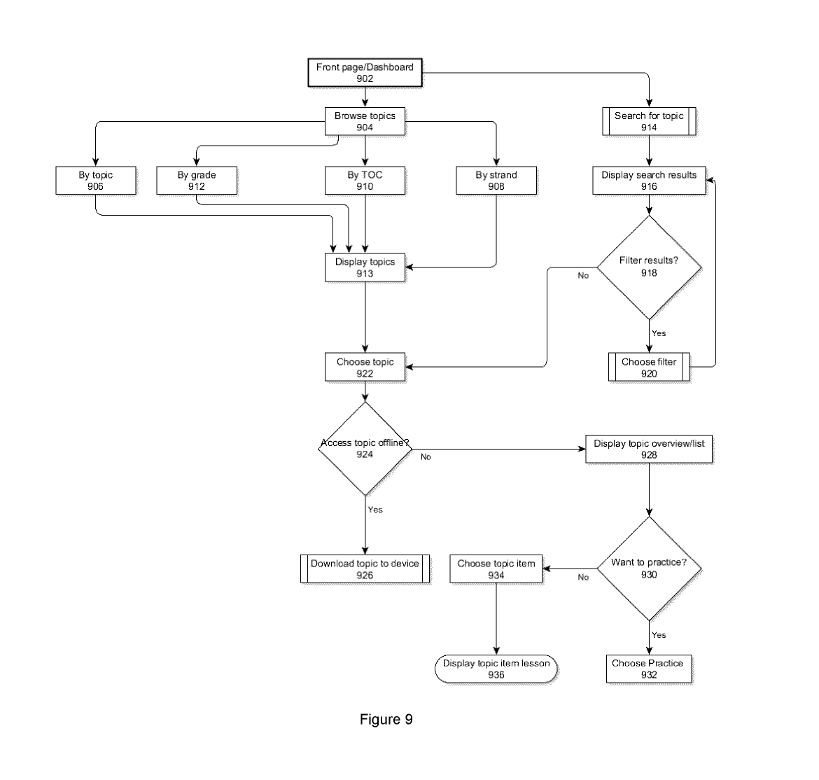

With reference to FIG. 9, the following describes how a user may navigate the core app to access content or practice/assessment materials.

Using a mobile interface 30, a user may search, browse or filters for a topic or content object by a table of contents, using a specific term, subject, strand, category, grade or curriculum standard, other meta-data, favourites, recently viewed. Some topics may not be available depending on the user's credentials and authorization. For example, a user in grade 1 may not be access materials from other grades.

User may have the option to view more or in-depth content around the topic including common digital formats, such as HTML, epub, pdf, images, videos, interactives.

Topics are displayed on the mobile interface, including, with reference to 902, on a dashboard. The user may browse for a topic, with reference to 904. Topic progression and related content recommendations can be displayed here, including from the analysis module.

If the content is not already local to device, the user may decide to download the topic to the application's local storage to be able to access it offline.

A list of topics/classes with quick access to practice or assessment questions may be available. Upon clicking on a topic, the mobile interface may display the content.

The user may have a variety of options including copying and pasting, generating user content, highlighting, note-taking, citations, dictionary, bookmarking, annotations, take notes/scratchpad, linking to external sites, several accessibility considerations including changing text size, text to speech (variety of voice options). The options may vary by the topic the user is on. For example, with a math topic, a toolbox with math-related tools such as building blocks and manipulatives may be shown.

User may choose to go to topic by browsing available topics (906), strands (908), using a table of contents (910), or by grade (912). Available topics may then be displayed, with reference to 913, for selection by the user. For each topic, an estimate of the amount of time it may take to review the topic may be displayed. The estimate may be pre-determined or calculated based on another students experience.

With reference to 914, if the user searches for a topic, search results may be displayed (916). The user may search using by entering text that may be optionally searched against keywords, author names, topic headings, or full text of available topics. The search results may be sorted by relevance, recommendations, issue, strand, or other criteria. With reference to 918, the user may choose to filter the results using the mobile interface, with reference to 920, including by selecting and identifying filter criteria. The filtered search results may then be displayed.

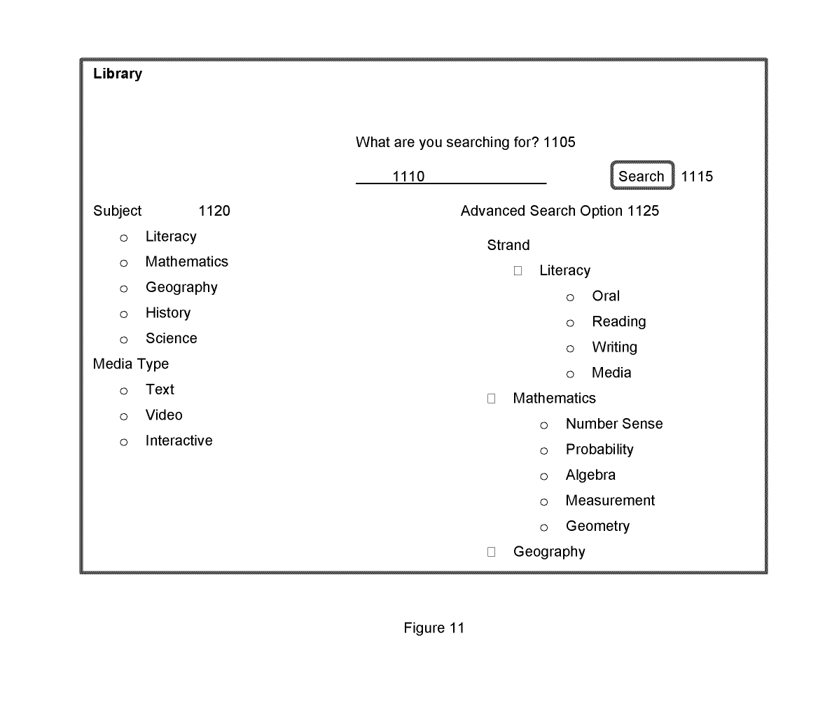

With reference to FIG. 11, a search option user interface may be displayed on a mobile interface 30. A search prompt message 1105 may prompt the user to enter text, such as title, author, keywords or other information into a search box 1110. A button 1115, such as with a “search” prompt, responsive to receiving a user interaction, such as a mouse click, touch gesture may trigger the display of pertinent content objects and issues. When a search is activated, text from box 1110 may be communicated from the mobile interface to one or more web applications which access content databases to generate a list of results. Search filters 1120 may be displayed and any of which may be selected such as by selecting a checkbox or highlighting the filter. A search filter 1120 may limit the search results to content that matches the selected filter. Advance search options 1125 may be activated and selected to filter the search results to specific strands, issues or topics.

With reference to FIGS. 9 and 922, if the user chooses a topic item, using any of the access modes, the topic item lesson is displayed on the mobile interface 30.

Learning analytics working in the background may monitor user interactions such as the time spent on questions/topics, topics currently reviewed and student averages. Additional learning analytics such as how the learning topics are being assigned to students (order of teaching/pedagogy), and effectiveness against student outcomes.

With reference to 924, if selected by the user, or the user preferences, the content relating to selected topic may be downloaded, 926, to the mobile interface so that it can be accessed while not connected to the system 10.

With reference to 928, a topic may include a topic overview or topic list. The overview or list may identify the main concepts of the topic, and resources available.

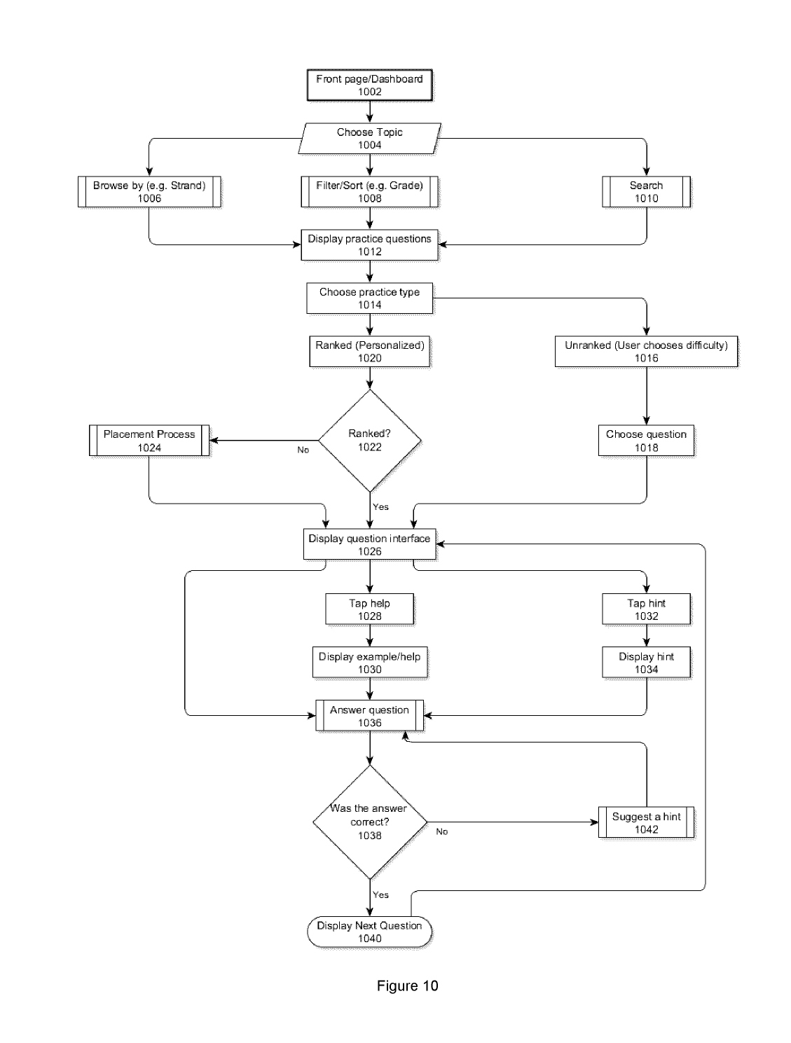

The user may be prompted whether to do a practice feature, with reference to 930. If selected, the mobile interface may then display available practice, with reference to 932, which is described in more detail with regard to FIG. 10.

With reference to 934, if no practice is selected, the user may select an item from the topic overview. The content 30 associated with the topic may be displayed on the mobile interface, this may include a lesson, using content objects, with reference to 936.

### Quick Practice/Assessment

The following is with reference quick practice and assessments and FIG. 10. From a dashboard 1002, the user may select to choose a topic, with reference to 1004.

The user may choose a topic by:
a. Browse 1006—The user may browse for a topic of interest. Browsing may be done in a variety of ways, including by strand, discipline, subject, difficult, curriculum standard, other meta-data.
b. Filter/Sorting 1008. The user may filter or sort for a topic. The filter or search may be done by grade, subject, difficulty, curriculum standard, other meta-data.
c. Search for a topic 1010. The user may search for a topic by entering text that may be optionally searched against key words, author names, topic headings, or full text of available topics.

Applicable practice/assessment questions may be displayed, with reference to 1012 and the user may chooses a practice/assessment type, with reference to 1014. The assessment may be unranked, where the user chooses or controls the difficulty of questions. The user chooses a question (1018) and a question interface is displayed (1026).

The user may choose ranked questions, with reference to 1020, where the questions are personalized to user based on skill level. The system may check if user has been ranked. If not, the user may be prompted to enter a placement process 1024, for example involving a series of 10 questions with a range of difficulty to determine the skill level of the user. The questions may be selected by the analysis module based on responses previously captured for other users.

The question interface may be displayed 1026 and shows additional ranked-related information, for example current rank, and score.

Help content may be requested, with reference to 1028 and may be displayed, with reference to 1030 in the form of video or other content to assist the user with the mobile interface 30 and answering questions. The content may be light-weight content if saved on the mobile interface.

User can request a hint, with reference to 1032 causing a hint is displayed to aid the user in solving the problem (1034). The hint may be requested by for example, tapping a hint button on the mobile interface, such as a “?” icon.

With reference to 1036, the user may answer the question based on type (for example, multiple choice or fill in blank). With reference to 1038, the system checks if the answer was correct.

If the answer was correct, the next question may be displayed, with reference to 1040. If the user is in ranked mode, the system may update the user's score/rank calculations, award any badges, and dynamically increase or decrease question difficulty.

If the question is incorrect, the system may suggest a hint (1042) and prompt the user to try again.

When the practice/assessment is complete, or upon the user requesting an end to the practice, and it is a gradeable assessment then the results may be saved to the master repository, or some other database. The assessment result may be added to the institution/educators gradebook system manually or automated via integration. Closed response assessments may be set to auto-graded, where the system can accurately determine if the answer is correct. Open responses may require manual review and grading by the teacher. Rich visualizations on grade results may be displayed in the app to teachers, admins, parents, students based on privacy laws and anonymous to others.

Learning analytics working in the background such as: time spent on questions/topics, topics currently reviewed, student averages, order the questions were presented and how effective the outcome may be tracked and analyzed, including by the analysis module.

The computer components, software modules, functions and data structures described herein may be connected directly or indirectly to each other in order to allow the flow of data needed for their operations. Various functional units described herein have been expressly or implicitly described as modules and agents, in order to more particularly emphasize their independent implementation and operation. It is also noted that an agent, module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The various functional units may be implemented in hardware circuits such as custom VLSI circuits or gate arrays; field-programmable gate arrays; programmable array logic; programmable logic devices; commercially available logic chips, transistors, and other such components. Modules implemented as software for execution by a processor or processors may comprise one or more physical or logical blocks of code that may be organized as one or more of objects, procedures, or functions. The modules need not be physically located together, but may comprise code stored in different locations, such as over several memory devices, capable of being logically joined for execution. Modules may also be implemented as combinations of software and hardware, such as a processor operating on a set of operational data or instructions.

1-12. (canceled)

13. An interactive education system comprising
content storage, the content storage containing a plurality of content objects, the content objects containing educational content connected as nodes in a non-linear manner;
a plurality of mobile interfaces, each authenticated to a student and each containing a subset of the content objects associated with the student, the mobile interface providing a display for accessing the content objects;
one or more educator interfaces, each authenticated to an educator, each educator interfaces associated with a plurality of the mobile interfaces based on a student information system.

14. The interactive system of claim 13 further comprising:
one or more administrative interfaces, the administrative interface connecting to the plurality of mobile interfaces, and the administrative interface configured to deploy, disable, enable, configure and update the plurality of mobile interfaces and educator interfaces.

15. The interactive system of claim 13 wherein the content objects comprising content objects created by a first educator and used by a second educator by distributing the content object to the plurality of mobile interfaces associated with the second educator.

16. The interactive system of claim 13 wherein the mobile interfaces are mobile devices, the mobile devices initialized with content and personal information associated with each student.

17. The interactive system of claim 16, wherein the mobile devices are re-used and re-initialized from a previous student using the mobile device.

18. The interactive system of claim 13, further comprising a data store on which analytics of the mobile interface are stored and an analysis module which uses the stored analytics to provide content objects to the mobile interfaces of students which the analysis module determines provide improved outcomes.

19. The interactive system of claim 13, further comprising a core application, the core application loaded on the mobile interfaces and displaying the content on the mobile interfaces.

20. A method of deploying an interactive education system to students and educators for an institution, the method comprising:
initializing and configuring a mobile interfaces for each student using personal information associated with each student extracted from a student information system operated by the institution;
populating the mobile interfaces by storing content on the mobile interface, including content objects associated with the education to be provided by the institution to the student, by connecting each mobile interface with a content store and authenticating each mobile interface;
gathering usage information from the mobile interfaces on the progress and use of the mobile interface by each student, and using the usage information to provide content recommendations
wherein the content objects are connected as nodes in a non-linear manner.

21. The method of claim 20, further comprising:
redeploying the mobile interfaces when the deployment for particular students are complete.

22. The method of claim 20, further comprising:
supplying additional content, and populating at least a subset of the mobile interfaces with the additional content.

23. The method of claim 22, wherein prior to the additional content being populated, receiving a request for the additional content from a student through the mobile interface and the additional content not being stored on the mobile interface.

24. The method of claim 22, wherein the additional content is created by an educator.

25. The method of claim 23, wherein the additional content is created by an educator.
